(19) United States
(12) Patent Application Publication
(10) Pub. No.: US 2024/0069408 A1
(43) Pub. Date: Feb. 29, 2024

(54) LIGHT ABSORPTION MATERIAL, RECORDING MEDIUM, INFORMATION RECORDING METHOD, AND INFORMATION READING METHOD

(71) Applicant: Panasonic Intellectual Property Management Co., Ltd., Osaka (JP)

(72) Inventors: SHINJI ANDO, Osaka (JP); MASAKO YOKOYAMA, Osaka (JP); KOTA ANDO, Osaka (JP)

(21) Appl. No.: 18/493,204

(22) Filed: Oct. 24, 2023

Related U.S. Application Data
(63) Continuation of application No. PCT/JP2022/019226, filed on Apr. 28, 2022.

(30) Foreign Application Priority Data
May 18, 2021 (JP) 2021-084185

(51) Int. Cl. G02F 1/361; G02F 1/35

(52) U.S. Cl. CPC G02F 1/361; G02F 1/3501; G02F 1/3523

(57) ABSTRACT

A light absorption material includes a compound represented by the following formula (1) as a main component:

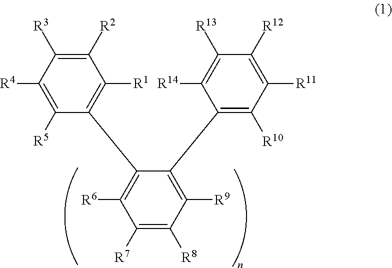

In the formula (1), R¹ to R¹⁴ each independently include at least one atom selected from the group consisting of H, C, N, O, F, P, S, Cl, I, and Br, and n is an integer greater than or equal to 2.

### BACKGROUND

### 1. Technical Field

The present disclosure relates to a light absorption material, a recording medium, an information recording method, and an information reading method.

### 2. Description of the Related Art

Among optical materials, such as light absorption materials, those materials having a non-linear optical effect are called non-linear optical materials. The non-linear optical effect means that when a substance is irradiated with intense light, such as laser beam, an optical phenomenon proportional to the second or higher power of the electric field of the irradiation light occurs in the substance. Examples of the optical phenomena include absorption, reflection, scattering, and light emission. Examples of the second-order non-linear optical effects proportional to the square of the electric field of irradiation light include second harmonic generation (SHG), Pockels effect, and parametric effect. Examples of the third-order non-linear optical effects proportional to the cube of the electric field of irradiation light include two-photon absorption, multiphoton absorption, third harmonic generation (THG), and Kerr effect. In the present specification, multiphoton absorption, such as two-photon absorption, is sometimes called non-linear optical absorption. Materials capable of non-linear optical absorption are sometimes written as non-linear optical absorption materials. In particular, materials capable of two-photon absorption are sometimes written as two-photon absorption materials.

Non-linear optical materials have been an active topic in numerous studies. In particular, inorganic non-linear optical materials that can be easily prepared as single crystals have been developed. In recent years, the development of organic non-linear optical materials is expected. Examples of the organic non-linear optical materials include organic dye materials. Compared to inorganic materials, organic materials not only offer a high degree of freedom in design, but also have a high non-linear optical constant. Furthermore, organic materials have a fast non-linear response. In the present specification, a non-linear optical material including an organic material is also written as an organic non-linear optical material.

### SUMMARY

In one general aspect, the techniques disclosed here feature a light absorption material including a compound represented by the following formula (1) as a main component:

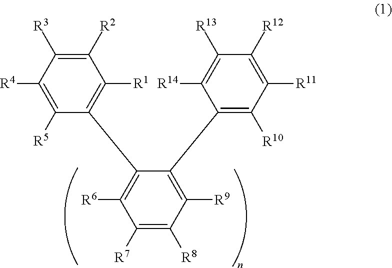

wherein R¹ to R¹⁴ each independently include at least one atom selected from the group consisting of H, C, N, O, F, P, S, Cl, I, and Br, and n is an integer greater than or equal to 2.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a flowchart regarding an information recording method using a recording medium including a light absorption material according to an embodiment of the present disclosure;

FIG. 1B is a flowchart regarding an information reading method using a recording medium including a light absorption material according to an embodiment of the present disclosure;

FIG. 2A is a graph illustrating a ¹H -NMR spectrum of a compound of EXAMPLE 1;

FIG. 2B is an enlarged view of the graph in FIG. 2A;

FIG. 3A is a graph illustrating a ¹H -NMR spectrum of a compound of EXAMPLE 2;

FIG. 3B is an enlarged view of the graph in FIG. 3A;

FIG. 4A is a graph illustrating a ¹-NMR spectrum of a compound of EXAMPLE 3;

FIG. 4B is an enlarged view of the graph in FIG. 4A;

FIG. 5A is a graph illustrating a ¹H-NMR spectrum of a compound of EXAMPLE 4;

FIG. 5B is an enlarged view of the graph in FIG. 5A;

FIG. 6A is a graph illustrating a ¹-NMR spectrum of a compound of EXAMPLE 5; and

FIG. 6B is an enlarged view of the graph in FIG. 6A.

### DETAILED DESCRIPTIONS

### Underlying Knowledge Forming Basis of the Present Disclosure

Two-photon absorption materials have attracted particular attention among other organic non-linear optical materials. The two-photon absorption means a phenomenon in which a compound is raised to an excited state by absorbing two photons almost at the same time. As the two-photon absorption, non-resonant two-photon absorption and resonant two-photon absorption are known. The non-resonant two-photon absorption means two-photon absorption that occurs in a wavelength region where there is no one-photon absorption band. In the non-resonant two-photon absorption, a compound absorbs two photons almost simultaneously and is promoted to a higher-order excited state. In the resonant two-photon absorption, a compound absorbs the first photon and further absorbs the second photon to be raised to a higher-order excited state. In the resonant two-photon absorption, a compound absorbs two photons sequentially.

A two-photon absorption material that further has fluorescence characteristics may be used as a fluorescent dye material in, for example, a two-photon fluorescence microscope. The use of such a two-photon absorption material in a three-dimensional optical memory leads to a possibility that the ON/OFF state of a recording layer is read by a system based on a change in fluorescence from the two-photon absorption material. In the current optical memories, the ON/OFF state of a recording layer is read by a system based on a change in optical reflectance and a change in optical absorbance of a two-photon absorption material. When this system is applied to a three-dimensional optical memory, unfortunately, crosstalk may be caused by interference between the recording layer of interest and other recording layers.

The two-photon absorption cross-section (GM value) is used as an index indicating the efficiency of two-photon absorption of two-photon absorption materials. The unit for the two-photon absorption cross-section is GM (10⁻⁵⁰ cm⁻⁴·s·molecule⁻¹·photon⁻¹). A great number of organic two-photon absorption materials having a large two-photon absorption cross-section have been proposed so far. For example, many compounds having as large a two-photon absorption cross-section as more than 500 GM have been reported (for example, Harry L. Anderson et al., “Two-Photon Absorption and the Design of Two-Photon Dyes”, Angew. Chem. Int. Ed. 2009, Vol. 48, pp. 3244-3266). In most of the reports, the two-photon absorption cross-section is measured using a laser beam with a wavelength longer than 600 nm. In particular, a near infrared ray having a wavelength longer than 750 nm is sometimes used as the laser beam.

However, for industrial applications, two-photon absorption materials are demanded that exhibit two-photon absorption characteristics when irradiated with a laser beam having a shorter wavelength. In the field of, for example, three-dimensional optical memories, a laser beam having a shorter wavelength can form a finer focused spot and thus allows for enhancement in the recording density of the three-dimensional optical memories. In the field of three-dimensional (3d) laser microfabrication too, a laser beam having a shorter wavelength realizes higher resolution modeling. Furthermore, a laser beam with a central wavelength of 405 nm is used under the Blu-ray (registered trademark) disc standards. Thus, great contribution will be made to the progress of industry by the development of a compound that exhibits excellent two-photon absorption characteristics when irradiated with light in the same wavelength region as the above short-wavelength laser beams.

Light-emitting devices that emit a high-intensity ultrashort pulsed laser beam tend to be large and unstable in operation, and are therefore difficult to adopt in industrial applications from the points of view of versatility and reliability. Considering this fact, two-photon absorption materials that are applied to industrial use are required to exhibit two-photon absorption characteristics even when irradiated with a low-intensity laser beam.

In a compound having two-photon absorption characteristics, the relationship between light intensity and two-photon absorption characteristics is represented by the equation (i) below. In the present specification, compounds having two-photon absorption characteristics are sometimes written as two-photon absorption compounds. The equation (i) is a formula for calculating the decrease −dI in light intensity when a sample including a two-photon absorption compound and having a very small thickness dz is irradiated with light having an intensity I. As can be seen from the equation (i), the decrease −dI in light intensity is expressed as the sum of a term proportional to the first power of the intensity I of the light incident on the sample, and a term proportional to the square of the intensity I.

$$- \frac{dI}{dz} = α I + {α}^{( 2 \}} {I}^{2} \qquad ( i )$$

In the equation (i), α is the one-photon absorption coefficient (cm⁻¹). α⁽²⁾ is the two-photon absorption coefficient (cm/W). From the equation (i), the intensity I of the incident light is expressed by α/α⁽²⁾ when the sample has equal amounts of one-photon absorption and two-photon absorption. That is, one-photon absorption preferentially occurs in the sample when the intensity I of the incident light is lower than α/α⁽²⁾. When the intensity I of the incident light is higher than α/α⁽²⁾, two-photon absorption occurs preferentially in the sample. Thus, a sample having a smaller value of α/α⁽²⁾ tends to exhibit two-photon absorption more preferentially upon irradiation with a low-intensity laser beam.

Furthermore, α and α⁽²⁾ can be represented by the equations (ii) and (iii) below, respectively. In the equations (ii) and (iii), ε is the molar absorption coefficient (mol⁻¹·L·cm⁻¹). N is the number of molecules (mol·cm⁻³) of the compound per unit volume of the sample. N_{A} is the Avogadro's constant. σ is the two-photon absorption cross-section (GM). h− (h bar) is the Dirac constant (J·s). ω is the angular frequency (rad/s) of the incident light.

$$α = 1000 \cdot ln 10 \cdot ε \cdot \frac{N}{{N}_{A}} \qquad ( ii )$$

$${α}^{( 2 )} = \frac{σ N}{ℏω} \qquad ( iii )$$

From the equations (ii) and (iii), α/α⁽²⁾ is determined by ε/σ. That is, a compound irradiated with a laser beam of a certain wavelength desirably has a large value of the ratio σ/ε of the two-photon absorption cross-section a to the molar absorption coefficient ε. Such a compound preferentially exhibits two-photon absorption upon irradiation with a low-intensity laser beam. It can be said that when a compound has a large value of the ratio σ/ε at a certain wavelength, the optical absorption at that wavelength is highly non-linear.

Conventionally, the conjugated system of a through-bond pi-conjugated compound is extended in order to achieve a large two-photon absorption cross-section. A through-bond pi-conjugated compound is a compound that has a conjugated system extended via covalent bonds. In a through-bond pi-conjugated compound, a plurality of pi-electron clouds interact with one another via covalent bonds. When the conjugated system of a through-bond pi-conjugated compound is extended, the absorption wavelength assigned to one-photon absorption tends to shift to the longer wavelength side. In the present specification, the shift of an absorption wavelength assigned to one-photon absorption to the longer wavelength side is sometimes written as the wavelength-increasing shift or the red shift. As a result of the wavelength-increasing shift of an absorption wavelength assigned to one-photon absorption, part of the wavelengths giving rise to one-photon absorption sometimes overlaps with the wavelength of the excitation light. Specific examples of the excitation light wavelengths include 405 nm specified in the Blu-ray (registered trademark) standards. The occurrence of one-photon absorption in a compound upon irradiation with excitation light significantly reduces the ratio a/c and thus tends to significantly lower non-linear optical absorption characteristics.

As a result of extensive studies, the present inventors have newly found that a compound of the formula (1) described later has excellent non-linear optical absorption characteristics with respect to light having a wavelength in a short wavelength region. In the present specification, the short wavelength region means a range of wavelengths including 405 nm, for example, a range of wavelengths greater than or equal to 390 nm and less than or equal to 420 nm. In particular, the compound represented by the formula (1) has excellent non-linear optical absorption characteristics with respect to light having a wavelength near 405 nm. Furthermore, the compound tends to exhibit higher non-linear optical absorption characteristics with increasing chain length.

### Outline of Aspects of the Present Disclosure

A light absorption material according to the first aspect of the present disclosure includes:
a compound represented by the following formula (1) as a main component:

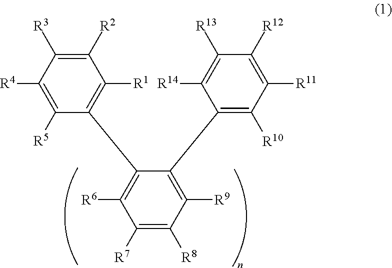

wherein R¹ to R¹⁴ each independently include at least one atom selected from the group consisting of H, C, N, O, F, P, S, Cl, I, and Br, and n is an integer greater than or equal to 2.

The light absorption material according to the first aspect has a large value of the ratio σ/ε of the two-photon absorption cross-section σ to the molar absorption coefficient ε with respect to light having a wavelength in the short wavelength region, and thus tends to exhibit excellent non-linear optical absorption characteristics. The light absorption material is improved in non-linear optical absorption characteristics with respect to light having a wavelength in the short wavelength region. When n in the formula (1) is greater than or equal to 2, the compound has, for example, a pi-stack structure. The pi-stack structure means a structure in which a plurality of pi-electron clouds interact with one another through spaces. Compounds having a pi-stack structure in the molecule are sometimes called through-space pi-conjugated compounds. In the compound of the formula (1), non-linear optical absorption characteristics tend to be enhanced with increasing chain length. The compound of the formula (1) also tends to exhibit high solubility in organic solvents.

In the second aspect of the present disclosure, for example, in the light absorption material according to the first aspect, R¹ to R¹⁴ may be each independently a hydrogen atom, a halogen atom, a saturated hydrocarbon group, a halogenated alkyl group, an unsaturated hydrocarbon group, a hydroxyl group, a carboxyl group, an alkoxycarbonyl group, an aldehyde group, an acyl group, an amide group, a nitrile group, an alkoxy group, an acyloxy group, a thiol group, an alkylthio group, a sulfonic acid group, an acylthio group, an alkylsulfonyl group, a sulfonamide group, a primary amino group, a secondary amino group, a tertiary amino group, or a nitro group.

In the third aspect of the present disclosure, for example, in the light absorption material according to the first or the second aspect, at least one selected from the group consisting of R², R³, R⁷, R⁸, R¹², and R¹³ may be an electron-donating group.

In the fourth aspect of the present disclosure, for example, in the light absorption material according to the third aspect, the electron-donating group may be an alkoxy group.

In the fifth aspect of the present disclosure, for example, in the light absorption material according to the third or the fourth aspect, the electron-donating group may be —OCH₃.

In the sixth aspect of the present disclosure, for example, in the light absorption material according to any one of the first to the fifth aspects, at least one selected from the group consisting of R⁵ and R¹⁰ may be an electron-withdrawing group.

In the seventh aspect of the present disclosure, for example, in the light absorption material according to the sixth aspect, the electron-withdrawing group may be a halogen group.

In the eighth aspect of the present disclosure, for example, in the light absorption material according to any one of the first to the seventh aspects, the compound may have a helical structure.

In the ninth aspect of the present disclosure, for example, in the light absorption material according to any one of the first to the eighth aspects, the compound may absorb specific light.

In the tenth aspect of the present disclosure, for example, the light absorption material according to any one of the first to the ninth aspects may be used in a device utilizing light having a wavelength of greater than or equal to 390 nm and less than or equal to 420 nm.

According to the second to the tenth aspects, the light absorption materials are improved in non-linear optical absorption characteristics with respect to light having a wavelength in the short wavelength region. The light absorption materials according to the second to the tenth aspects are suitable for use in devices that utilize light having a wavelength of greater than or equal to 390 nm and less than or equal to 420 nm.

A recording medium according to the eleventh aspect of the present disclosure includes:
a recording layer including the light absorption material according to any one of the first to the tenth aspects.

According to the eleventh aspect, the light absorption material has improved non-linear optical absorption characteristics with respect to light having a wavelength in the short wavelength region. The recording medium includes the recording layer containing the light absorption material and can record information with a high recording density.

An information recording method according to the twelfth aspect of the present disclosure includes:
providing a light source that emits light having a wavelength of greater than or equal to 390 nm and less than or equal to 420 nm; and
focusing the light from the light source and applying the light to the recording layer in the recording medium according to the eleventh aspect.

According to the twelfth aspect, the light absorption material has improved non-linear optical absorption characteristics with respect to light having a wavelength in the short wavelength region. The information recording method involves the recording medium that has the recording layer including the light absorption material, and thus can record information with a high recording density.

An information reading method according to the thirteenth aspect of the present disclosure is a method for reading information recorded by, for example, the information recording method according to the twelfth aspect,
the information reading method including:
   applying light to the recording layer to measure an optical characteristic of the recording layer; and
   reading the information from the recording layer.

In the fourteenth aspect of the present disclosure, for example, in the information reading method according to the thirteenth aspect, the optical characteristic may be intensity of light reflected at the recording layer.

According to the thirteenth or the fourteenth aspect, information can be read easily.

Hereinbelow, embodiments of the present disclosure will be described with reference to the drawings. The present disclosure is not limited to the embodiments below.

### EMBODIMENTS

A light absorption material according to an embodiment includes a compound A represented by the following formula (1):

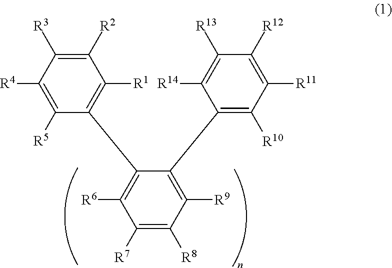

In the formula (1), R¹ to R¹⁴ each independently include at least one atom selected from the group consisting of H, C, N, O, F, P, S, Cl, I, and Br. R¹ to R¹⁴ may be each independently a hydrogen atom, a halogen atom, a saturated hydrocarbon group, a halogenated alkyl group, an unsaturated hydrocarbon group, a hydroxyl group, a carboxyl group, an alkoxycarbonyl group, an aldehyde group, an acyl group, an amide group, a nitrile group, an alkoxy group, an acyloxy group, a thiol group, an alkylthio group, a sulfonic acid group, an acylthio group, an alkylsulfonyl group, a sulfonamide group, a primary amino group, a secondary amino group, a tertiary amino group, or a nitro group.

Examples of the halogen atoms include F, Cl, Br, and I. In the present specification, a halogen atom may be referred to as a halogen group.

For example, the saturated hydrocarbon group is an aliphatic saturated hydrocarbon group. Specific examples of the aliphatic saturated hydrocarbon groups include alkyl groups. The number of carbon atoms in the alkyl groups is not particularly limited, and is, for example, greater than or equal to 1 and less than or equal to 20. For the reason that the synthesis of the compound A is facilitated, the number of carbon atoms in the alkyl groups may be greater than or equal to 1 and less than or equal to 10, or may be greater than or equal to 1 and less than or equal to 5. Controlling of the number of carbon atoms in the alkyl groups allows for control of the solubility of the compound A with respect to a solvent or a resin composition. The alkyl groups may be linear, branched, or cyclic. At least one hydrogen atom contained in the alkyl group may be substituted with a group containing at least one atom selected from the group consisting of N, O, P, and S. Examples of the alkyl groups include methyl group, ethyl group, propyl group, butyl group, 2-methylbutyl group, pentyl group, hexyl group, 2,3-dimethylhexyl group, heptyl group, octyl group, nonyl group, decyl group, undecyl group, dodecyl group, tridecyl group, tetradecyl group, pentadecyl group, hexadecyl group, heptadecyl group, octadecyl group, nonadecyl group, eicosyl group, 2-methoxybutyl group, and 6-methoxyhexyl group.

The halogenated alkyl group means an alkyl group substituted by a halogen atom in place of at least one hydrogen atom. The halogenated alkyl group may be an alkyl group substituted by halogen atoms in place of all the hydrogen atoms. Examples of the alkyl groups include those described above. Specific examples of the halogenated alkyl groups include —CF₃.

The unsaturated hydrocarbon group contains an unsaturated bond, such as a carbon-carbon double bond or a carbon-carbon triple bond. For example, the number of unsaturated bonds contained in the unsaturated hydrocarbon groups is greater than or equal to 1 and less than or equal to 5. The number of carbon atoms in the unsaturated hydrocarbon groups is not particularly limited, and may be, for example, greater than or equal to 2 and less than or equal to 20, may be greater than or equal to 2 and less than or equal to 10, or may be greater than or equal to 2 and less than or equal to 5. The unsaturated hydrocarbon groups may be linear, branched, or cyclic. At least one hydrogen atom contained in the unsaturated hydrocarbon group may be substituted with a group containing at least one atom selected from the group consisting of N, O, P, and S. Examples of the unsaturated hydrocarbon groups include vinyl group and ethynyl group.

The hydroxyl group is represented by —OH. The carboxyl group is represented by —COOH. The alkoxycarbonyl group is represented by —COORₐ. The aldehyde group is represented by —COH. The acyl group is represented by —COR_{b}. The amide group is represented by —CONR_{c}R_{d}. The nitrile group is represented by —CN. The alkoxy group is represented by —ORₑ. The acyloxy group is represented by —OCOR_{f}. The thiol group is represented by —SH. The alkylthio group is represented by —SR_{g}. The sulfonic acid group is represented by —SO₃H. The acylthio group is represented by —SCORₕ. The alkylsulfonyl group is represented by —SO₂Rᵢ. The sulfonamide group is represented by —SO₂NRⱼRₖ. The primary amino group is represented by —NH₂. The secondary amino group is represented by —NHRₗ. The tertiary amino group is represented by —NRₘRₙ. The nitro group is represented by —NO₂. Rₐ to Rₙ are each independently an alkyl group. Examples of the alkyl groups include those described hereinabove. R_{c} and R_{d} in the amide group, and Rⱼ and Rₖ in the sulfonamide group may be each independently a hydrogen atom.

Specific examples of the alkoxycarbonyl groups include —COOCH₃, —COO(CH₂)₃CH₃ and —COO(CH₂)₇CH₃. Specific examples of the acyl groups include —COCH₃. Specific examples of the amide groups include —CONH₂. Specific examples of the alkoxy groups include methoxy group, ethoxy group, 2-methoxyethoxy group, butoxy group, 2-methylbutoxy group, 2-methoxybutoxy group, 4-ethylthiobutoxy group, pentyloxy group, hexyloxy group, heptyloxy group, octyloxy group, nonyloxy group, decyloxy group, undecyloxy group, dodecyloxy group, tridecyloxy group, tetradecyloxy group, pentadecyloxy group, hexadecyloxy group, heptadecyloxy group, octadecyloxy group, nonadecyloxy group, and eicosyloxy group. Specific examples of the acyloxy groups include —OCOCH₃. Specific examples of the alkylthio groups include —SCH₃. Specific examples of the acylthio groups include —SCOCH₃. Specific examples of the alkylsulfonyl groups include —SO₂CH₃. Specific examples of the sulfonamide groups include —SO₂NH₂. Specific examples of the tertiary amino groups include —N(CH₃)₂.

In the formula (1), at least one selected from the group consisting of R², R³, R⁷, R⁸, R¹², and R¹³ is, for example, an electron-donating group. R², R³, R⁷, R⁸, R¹², and R¹³ may be each an electron-donating group. A compound A in which R², R³, R⁷, R⁸, R¹², or R¹³ is an electron-donating group may be synthesized easily. Such a compound A also tends to have high non-linear optical absorption characteristics.

The electron-donating group means, for example, a substituent having a negative value of the substituent constant σ_{P} in the Hammett equation. Examples of the electron-donating groups include alkyl groups, alkoxy groups, hydroxyl groups, and amino groups. The electron-donating group may be an alkoxy group or may be —OCH₃. The electron-donating group may be an alkyl group or may be —C(CH₃)₃.

In the formula (1), at least one selected from the group consisting of R⁵ and R¹⁰ is, for example, an electron-withdrawing group. Each of R⁵ and R¹⁰ may be an electron-withdrawing group. A compound A in which R⁵ or R¹⁰ is an electron-withdrawing group may be synthesized easily. Such a compound A also tends to have excellent stability.

The electron-withdrawing group means, for example, a substituent having a positive value of the substituent constant σ_{P}. Examples of the electron-withdrawing groups include halogen groups, carboxyl groups, nitro groups, thiol groups, sulfonic acid groups, acyloxy groups, alkylthio groups, alkylsulfonyl groups, sulfonamide groups, acyl groups, acylthio groups, alkoxycarbonyl groups, and halogenated alkyl groups. The electron-withdrawing group may be a halogen group or may be —Br.

Among R¹ to R¹⁴ in the formula (1), R¹, R⁴, R⁶, R⁹, R¹¹, and R¹⁴ may each have a smaller volume than the substituents other than R¹, R⁴, R⁶, R⁹, R¹¹, and R¹⁴. In this case, steric hindrance is unlikely to occur in R¹, R⁴, R⁶, R⁹, R¹¹, and R¹⁴. As a result, a pi-stack structure is easily formed in the compound A, and non-linear optical absorption characteristics tend to be enhanced. R¹, R⁴, R⁶, R⁹, R¹¹, and R¹⁴ may be each a hydrogen atom.

In the formula (1), n is an integer of greater than or equal to 2. The letter n may be greater than or equal to 6, may be greater than or equal to 10, may be greater than or equal to 12, or may be greater than or equal to 14. The greater the value of n, the longer the chain length of the compound A. The compound A tends to attain higher enhancements in non-linear optical absorption characteristics with increasing chain length. Specifically, unlike the conventional through-bond pi-conjugated compounds, the compound A tends to have no or a small decrease in non-linear optical absorption characteristics even when the pi-conjugated system is extended. The upper limit of the value of n is not particularly limited, and is, for example, 46. Specific examples of the values of n include 2, 6, 10, 12, and 14.

For example, the compound A has a helical structure. The helical structure may be right-handed or left-handed. The light absorption material may include a mixture of a compound A having a right-handed helical structure and a compound A having a left-handed helical structure. The winding direction of the helical structure of the compound A tends to be easily reversed in a solution.

When the compound A has a helical structure, a pi-stack structure is easily formed in the compound A. When, for example, n in the formula (1) is 2, the compound A has an orthophenylene tetramer structure. When this compound A has a helical structure, the two orthophenylenes located at the terminals of the compound A participate in the formation of a pi-stack structure. The larger the value of n in the formula (1), the more the orthophenylenes available for the formation of a pi-stack structure. Incidentally, no pi-stack structures are formed when n in the formula (1) is 1, namely, when the structure is an orthophenylene trimer. Thus, the orthophenylene trimer structure scarcely exhibits non-linear optical absorption characteristics.

Specific examples of the compounds A represented by the formula (1) include compounds B represented by the formula (2) below:

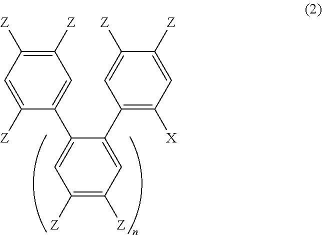

In the formula (2), the plurality of Z are the same as one another. R², R³, R⁷, R⁸, R¹², and R¹³ in the formula (1) correspond to Zs at the corresponding positions. Z is, for example, an alkoxy group, such as —OCH₃. In the formula (2), the plurality of X are the same as one another. R⁵ and R¹⁰ in the formula (1) correspond to Xs at the corresponding positions. X is, for example, a halogen group, such as —Br.

The compound B represented by the formula (2) may be synthesized by any method without limitation. For example, the compound B may be synthesized using such a reaction as the coupling reaction described in Examples.

The compound A represented by the formula (1) has a large value of the ratio σ/ε of the two-photon absorption cross-section σ to the molar absorption coefficient ε with respect to light having a wavelength in the short wavelength region, and thus exhibits high non-linear optical absorption characteristics. The ratio σ/ε of the compound A with respect to light having a wavelength in the short wavelength region tends to be higher than those of the conventional two-photon absorption compounds disclosed in, for example, Japanese Patents Nos. 5769151, 5821661, and 5659189. As an example, the compound A tends to exhibit non-linear optical absorption markedly when irradiated with light having a wavelength of 405 nm. As described hereinabove, the compound A tends to attain higher enhancements in non-linear optical absorption characteristics with increasing chain length. For example, the compound A enhanced in non-linear optical absorption characteristics allows for enhancements in the recording density of three-dimensional optical memories.

The two-photon absorption cross-section of the compound A irradiated with light having a wavelength of 405 nm may be greater than or equal to 1 GM, may be greater than or equal to 10 GM, may be greater than or equal to 30 GM, may be greater than or equal to 50 GM, may be greater than or equal to 70 GM, may be greater than or equal to 100 GM, may be greater than or equal to 200 GM, or may be greater than or equal to 300 GM. The upper limit of the two-photon absorption cross-section of the compound A is not particularly limited, and is, for example, 10000 GM. For example, the two-photon absorption cross-section may be measured by the z-scan technique described in J. Opt. Soc. Am. B, 2003, Vol. 20, p. 529. The z-scan technique is widely used as a method for measuring non-linear optical constants. In the z-scan technique, a measurement sample is moved along the beam irradiation direction near the focal point at which the laser beam is focused. During this process, the change in the amount of light transmitted through the measurement sample is recorded. In the z-scan technique, the power density of incident light changes depending on the location of the measurement sample. Thus, when the measurement sample absorbs light non-linearly, the amount of transmitted light is attenuated when the measurement sample is located near the focal point of the laser beam. The two-photon absorption cross-section may be calculated by fitting the changes in the amount of transmitted light based on the theoretical curve predicted from conditions, such as the intensity of the incident light, the thickness of the measurement sample, and the concentration of the compound A in the measurement sample.

The molar absorption coefficient of the compound A with respect to light having a wavelength of 405 nm may be less than or equal to 50 mol⁻¹·L·cm⁻¹, may be less than or equal to 10 mol⁻¹·L·cm⁻¹, may be less than or equal to 5 mol⁻¹·L·c⁻¹, may be less than or equal to 2 mol⁻¹·L·cm⁻¹, or may be less than or equal to 1 mol⁻¹·L·cm⁻¹. The lower limit of the molar absorption coefficient of the compound A is not particularly limited, and is, for example, 0.01 mol⁻¹·L·cm⁻¹. The molar absorption coefficient may be measured by, for example, a method in accordance with the manual specified in Japanese Industrial Standards (JIS) K0115: 2004. In the measurement of the molar absorption coefficient, a light source is used that emits light with such a photon density that the compound A does not substantially exhibit two-photon absorption. In the measurement of the molar absorption coefficient, furthermore, the concentration of the compound A is adjusted to 500 mmol/L. This concentration is very high compared to the concentration in the measurement test of the molar absorption coefficient of an optical absorption peak. The molar absorption coefficient may be used as an index of one-photon absorption.

The compound A has a large value of the ratio σ/ε of the two-photon absorption cross-section σ (GM) to the molar absorption coefficient ε (mol⁻¹·L·cm⁻¹) with respect to light having a wavelength in the short wavelength region. The ratio σ/ε of the compound A with respect to light having a wavelength of 405 nm may be greater than or equal to 20, may be greater than or equal to 30, may be greater than or equal to 50, may be greater than or equal to 70, may be greater than or equal to 100, may be greater than or equal to 150, or may be greater than or equal to 200. The upper limit of the ratio σ/ε of the compound A is not particularly limited, and is, for example, 5,000.

When the compound A absorbs two photons, the compound A absorbs about twice as much energy as the energy of light applied to the compound A. The wavelength of light having about twice the energy of 405 nm wavelength light is, for example, 200 nm. When the compound A is irradiated with light having a wavelength of about 200 nm, one-photon absorption may occur in the compound A. Furthermore, one-photon absorption may occur in the compound A when the compound A is irradiated with light having a wavelength close to the wavelength region causing two-photon absorption.

The compound A also tends to have high solubility in an organic solvent. This solubility is significantly enhanced when the winding direction of the helical structure of the compound A can be easily reversed in a solution. As an example, the solubility of the compound A in 1 mL of chloroform at 25° C. is greater than or equal to 100 mg. The upper limit of this solubility is not particularly limited, and is, for example, 500 mg. The compound A that exhibits high solubility with respect to an organic solvent is easy to handle and is easy to use in device applications.

The light absorption material of the present embodiment may include the compound A represented by the formula (1) as a main component. The term “main component” means that the component represents the highest weight ratio among the components contained in the light absorption material. For example, the light absorption material consists essentially of the compound A. The phrase “consist essentially of” means that other components that will alter the essential characteristics of the material mentioned are excluded. However, the light absorption material may contain impurities in addition to the compound A. As a result of including the compound A represented by the formula (1), the light absorption material of the present embodiment tends to exhibit excellent non-linear optical absorption characteristics with respect to light having a wavelength in the short wavelength region. For example, the light absorption material of the present embodiment that includes the compound A functions as a two-photon absorption material.

For example, the light absorption material of the present embodiment is used in a device that utilizes light having a wavelength in the short wavelength region. As an example, the light absorption material of the present embodiment is used in a device that utilizes light having a wavelength of greater than or equal to 390 nm and less than or equal to 420 nm. Examples of such devices include recording media, modeling machines, and fluorescence microscopes. Examples of the recording media include three-dimensional optical memories. Specific examples of the three-dimensional optical memories include three-dimensional optical discs. Examples of the modeling machines include three-dimensional (3d) laser microfabrication machines, such as 3D printers. Examples of the fluorescence microscopes include two-photon fluorescence microscopes. The light utilized in these devices has a high photon density at, for example, near the focal point. The power density near the focal point of the light used in the device is, for example, greater than or equal to 0.1 W/cm² and less than or equal to 1.0×10²⁰ W/cm². The power density near the focal point of the light may be greater than or equal to 1.0 W/cm², may be greater than or equal to 1.0×10² W/cm², or may be greater than or equal to 1.0×10⁵ W/cm². For example, a femtosecond laser, such as a Ti:sapphire laser, or a pulsed laser having a picosecond to nanosecond pulse width, such as a semiconductor laser, may be used as the light source of the device.

For example, a recording medium includes a thin film called a recording layer. In the recording medium, information is recorded in the recording layer. As an example, the thin film as the recording layer includes the light absorption material of the present embodiment. That is, another aspect of the present disclosure provides a recording medium that includes the light absorption material including the compound A described hereinabove.

In addition to the light absorption material, the recording layer may further include a polymer compound that functions as a binder. The recording medium may include a dielectric layer in addition to the recording layer. For example, the recording medium includes a plurality of recording layers and a plurality of dielectric layers. In the recording medium, a plurality of recording layers and a plurality of dielectric layers may be alternately stacked on top of one another.

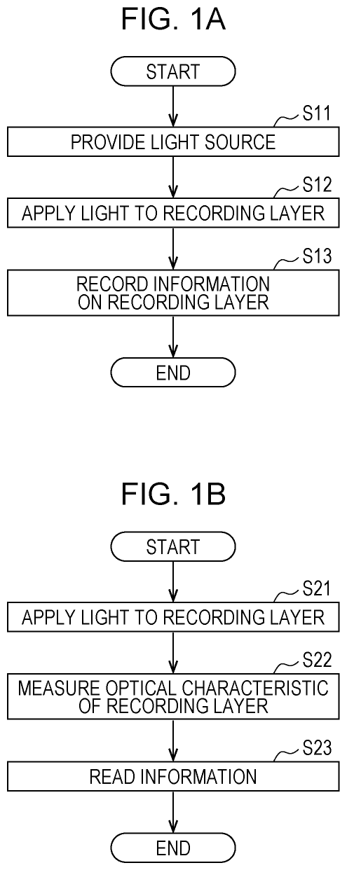

Next, a method for recording information using the recording medium described above will be described. FIG. 1A is a flowchart regarding an information recording method using the recording medium described above. First, in step S11, a light source is provided that emits light having a wavelength of greater than or equal to 390 nm and less than or equal to 420 nm. For example, a femtosecond laser, such as a Ti:sapphire laser, or a pulsed laser having a picosecond to nanosecond pulse width, such as a semiconductor laser, may be used as the light source. Next, in step S12, the light from the light source is focused with, for example, a lens and is applied to the recording layer in the recording medium. Specifically, the light from the light source is focused with a lens or other device and is applied to a recording region in the recording medium. The power density near the focal point of the light is, for example, greater than or equal to 0.1 W/cm² and less than or equal to 1.0×10²⁰ W/cm². The power density near the focal point of the light may be greater than or equal to 1.0 W/cm², may be greater than or equal to 1.0×10² W/cm², or may be greater than or equal to 1.0×10⁵ W/cm². In the present specification, the recording region means a spot that is present in the recording layer and, by being irradiated with light, allows information to be recorded therein.

In the recording region that has been irradiated with the light, a physical change or a chemical change occurs. For example, heat is generated when the compound A that has absorbed the light returns from the transition state to the ground state. This heat denatures the binder present in the recording region to give rise to a change in optical characteristics of the recording region. For example, the change occurs in the intensity of light reflected from the recording region, the reflectance of light at the recording region, the absorbance of light at the recording region, or the refractive index of light at the recording region. The recording region irradiated with the light may change the intensity of fluorescent light or the wavelength of fluorescent light emitted from the recording region. In this manner, information can be recorded in the recording layer, specifically, the recording region (step S13).

Next, a method for reading information using the recording medium described hereinabove will be described. FIG. 1B is a flowchart regarding an information reading method using the recording medium described hereinabove. First, in step S21, light is applied to the recording layer in the recording medium. Specifically, light is applied to a recording region in the recording medium. The light used in step S21 may be the same as or different from the light used to record information on the recording medium. Next, in step S22, an optical characteristic of the recording layer is measured. Specifically, an optical characteristic of the recording region is measured. For example, the optical characteristic of the recording region measured in step S22 may be the intensity of light reflected from the recording region. The optical characteristic of the recording region measured in step S22 may be, for example, the reflectance of light at the recording region, the absorbance of light at the recording region, the refractive index of light at the recording region, or the intensity of fluorescent light or the wavelength of fluorescent light emitted from the recording region. Next, in step S23, information is read from the recording layer, specifically, the recording region.

In the information reading method, the recording region storing the information may be searched in the following manner. First, light is applied to a specific region of the recording medium. This light may be the same as or different from the light used to record the information on the recording medium. Next, an optical characteristic of the region irradiated with the light is measured. For example, the optical characteristic may be the intensity of light reflected from the region, the reflectance of light at the region, the absorbance of light at the region, the refractive index of light at the region, the intensity of fluorescent light emitted from the region, or the wavelength of fluorescent light emitted from the region. Based on the optical characteristic measured, judgement is made as to whether the region irradiated with the light is the recording region. For example, the region is judged to be the recording region when the intensity of light reflected from the region is less than or equal to a predetermined value. When, on the other hand, the intensity of light reflected from the region is more than a predetermined value, the region is judged not to be the recording region. However, whether the region irradiated with the light is the recording region may be judged in any other manner without limitation. For example, the region may be judged to be the recording region when the intensity of light reflected from the region is more than a predetermined value. Furthermore, the region may be judged not to be the recording region when the intensity of light reflected from the region is less than or equal to a predetermined value. After the region has been judged not to be the recording region, the similar operation is conducted on another region of the recording medium until the recording region is identified.

For example, the methods described above for recording and reading information using the recording medium may be performed with a known recording device. For example, the recording device includes a light source that applies light to a recording region in the recording medium, a measuring device that measures an optical characteristic of the recording region, and a controller that controls the light source and the measuring device.

Modeling machines form shapes by, for example, irradiating a photocurable resin composition with light to cure the resin composition. As an example, a photocurable resin composition for three-dimensional (3d) laser microfabrication includes the light absorption material of the present embodiment. For example, the photocurable resin composition includes a polymerizable compound and a polymerization initiator in addition to the light absorption material. The photocurable resin composition may further include an additive, such as a binder resin. The photocurable resin composition may include an epoxy resin.

A fluorescence microscope applies light to, for example, a biological sample containing a fluorescent dye material and allows for observation of fluorescence emitted from the dye material. As an example, a fluorescent dye material that is added to a biological sample includes the light absorption material of the present embodiment.

### EXAMPLES

Hereinbelow, the present disclosure will be described in greater detail by way of Examples. Examples discussed below are only illustrative and do not limit the scope of the present disclosure.

### Example 1

### Synthesis of Compound OP4Br

First, a tetrahydrofuran solution containing 2,2′-dibromo-4,4′,5,5′-tetramethoxybiphenyl was prepared in an argon atmosphere. Next, 28 mmol of a 1.57 mol/L hexane solution of n-butyllithium was added to the solution, and the mixture was stirred at −78° C. for 30 minutes. Next, copper cyanide powder (1.04 g, 12 mmol) was added to the reaction solution, and the mixture was stirred at room temperature for 2 hours. Next, duroquinone powder (5.70 g, 35 mmol) was added to the reaction solution, and the mixture was stirred at room temperature for 1.5 hours. In this manner, the coupling reaction of 2,2′-dibromo-4,4′,5,5′-tetramethoxybiphenyl proceeded. Next, the reaction solution was poured into an aqueous ammonia solution, and the organic layer was extracted using ethyl acetate. The organic layer extracted was washed with a saturated aqueous ammonium chloride solution and water, and was dried with magnesium sulfate. After drying, ethyl acetate was evaporated by vacuum distillation. The resultant crude product was purified by column chromatography to give a compound OP4Br of Example 1. The compound OP4Br is represented by the following formula (3):

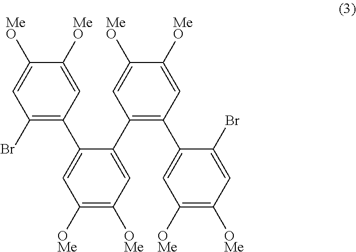 [SMILES: COc1cc(Br)c(-c2cc(OC)c(OC)cc2-c2cc(OC)c(OC)cc2-c2cc(OC)c(OC)cc2Br)cc1OC]

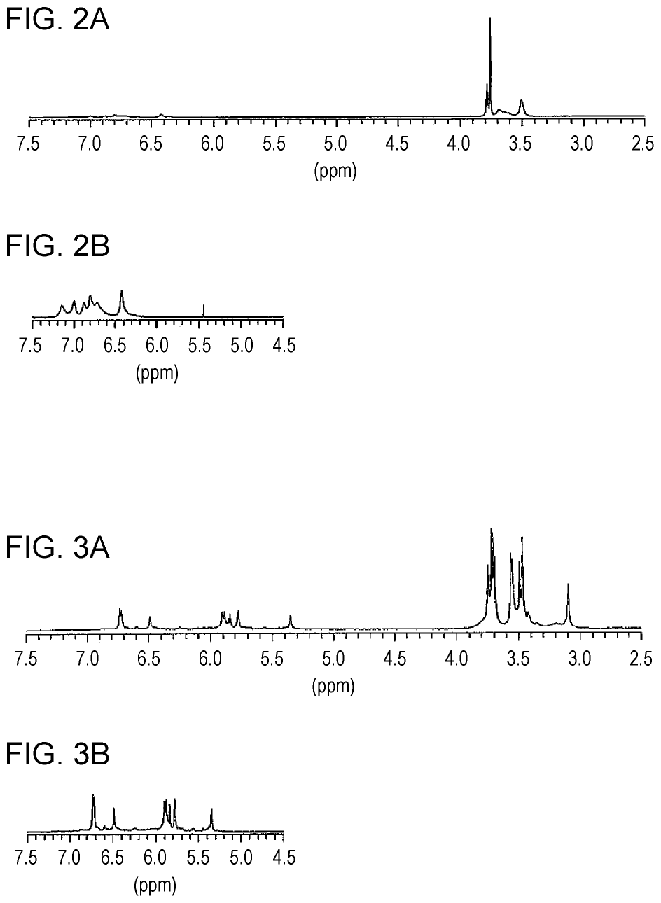

The compound OP4Br was identified by ¹H-NMR and mass spectrometry. FIG. 2A is a graph illustrating the ¹H-NMR spectrum of the compound OP4Br of Example 1. FIG. 2B is an enlarged view of the graph in FIG. 2A. The ¹H-NMR spectrum of the compound OP4Br, and the results of the mass spectrometry by electrospray ionization-time-of-flight mass spectrometry using a high-resolution mass spectrometer (HRMS) were as described below. The ¹H-NMR spectrum shows that the peak assigned to hydrogen atoms bonded to the benzene ring shifted to the higher magnetic field side. This result indicates that the compound OP4Br has a helical structure.

¹H-NMR (600 MHz, CD₃CN): δ (ppm) 7.15-6.73 (m, 6H), 6.43 (br. 2H), 3.78 (s. 6H), 3.74 (br. 12H), 3.51 (s. 6H). HRMS (ESI-TOF mass): calcd. for C₃₂H₃₂Br₂O₈ [M]⁺: m/z=704.04; found: 704.00.

### Example 2

### Synthesis of Compound OP8Br

First, a tetrahydrofuran solution (42 mL) containing the compound OP4Br (1.01 g, 1.4 mmol) synthesized in Example 1 was prepared in an argon atmosphere. Next, 2.2 mmol of a 1.58 mol/L hexane solution of n-butyllithium was added to the solution, and the mixture was stirred at −78° C. for 30 minutes. Next, copper cyanide powder (64.6 mg, 0.72 mmol) was added to the reaction solution, and the mixture was stirred at room temperature for 2 hours. Next, duroquinone powder (356 mg, 2.2 mmol) was added to the reaction solution, and the mixture was stirred at room temperature for 1.5 hours. In this manner, the coupling reaction of the compound OP4Br proceeded. Next, the reaction solution was poured into an aqueous ammonia solution, and the organic layer was extracted using ethyl acetate. The organic layer extracted was washed with a saturated aqueous ammonium chloride solution and water, and was dried with anhydrous magnesium sulfate. After drying, ethyl acetate was evaporated by vacuum distillation. The resultant crude product was purified by column chromatography to give a compound OP8Br of Example 2. The compound OP8Br is represented by the following formula (4):

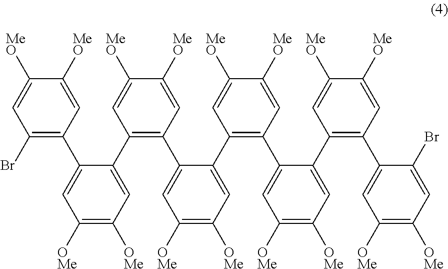 [SMILES: COc1cc(Br)c(-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2Br)cc1OC]

The compound OP8Br was identified by ¹H-NMR. FIG. 3A is a graph illustrating the ¹H-NMR spectrum of the compound OP8Br of Example 2. FIG. 3B is an enlarged view of the graph in FIG. 3A. The ¹H-NMR spectrum of the compound OP8Br was as described below. Similarly to Example 1, the ¹H-NMR spectrum indicates that the compound OP8Br has a helical structure.

¹H-NMR (600 MHz, CD₃CN): δ (ppm) 6.73 (s, 2H), 6.72 (s, 2H), 6.48 (s, 2H), 5.90 (s, 2H), 5.89 (s, 2H), 5.83 (s, 2H), 5.77 (s, 2H), 5.34 (s, 2H), 3.73 (s, 6H), 3.71 (s, 6H), 3.70 (s, 6H), 3.55 (s, 6H), 3.54 (s, 6H), 3.48 (s, 6H), 3.46 (s, 6H), 3.09 (s, 6H).

### Example 3

### Synthesis of Compound OP12Br

First, an orthophenylene dodecamer represented by the following formula (5) was provided.

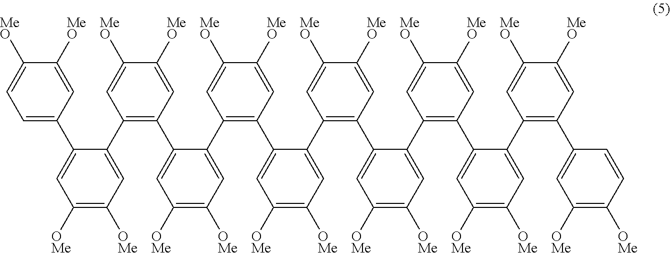 [SMILES: COc1ccc(-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2ccc(OC)c(OC)c2)cc1OC]

Next, a dimethylformamide solution (20 mL) containing N-bromosuccinimide (18.5 g, 1.1 mmol) and the above orthophenylene dodecamer (0.90 g, 0.5 mmol) was prepared and was stirred at 0° C. for 1 hour. Furthermore, the solution was warmed to room temperature and was stirred for 4 hours. In this manner, the bromination reaction of the orthophenylene dodecamer proceeded. Next, the reaction solution was poured into water, and extraction was performed using chloroform. The extract was washed with saturated brine and was dried with magnesium sulfate. After drying, chloroform was evaporated by vacuum distillation. The resultant crude product was purified by column chromatography to give a compound OP12Br of Example 3. The compound OP12Br is represented by the following formula (6):

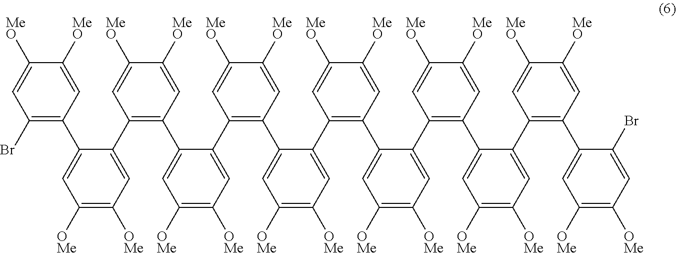 [SMILES: COc1cc(Br)c(-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2Br)cc1OC]

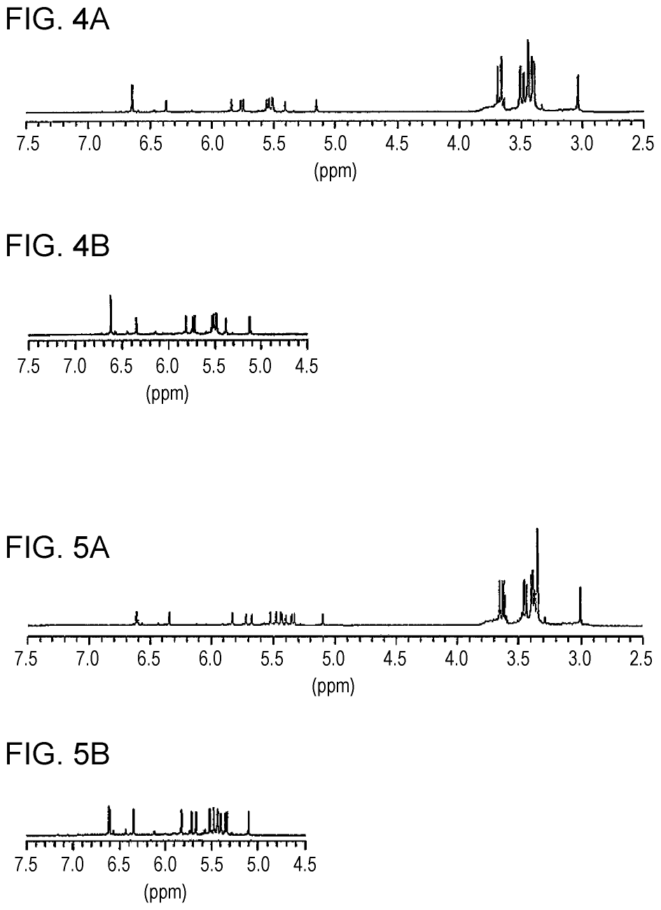

The compound OP12Br was identified by ¹H-NMR. FIG. 4A is a graph illustrating the ¹HI-NMR spectrum of the compound OP12Br of Example 3. FIG. 4B is an enlarged view of the graph in FIG. 4A. The ¹H-NMR spectrum of the compound OP12Br was as described below. Similarly to Example 1, the ¹H-NMR spectrum indicates that the compound OP12Br has a helical structure.

¹H-NMR (600 MHz, CD₃CN): δ (ppm) 6.64 (s, 2H), 6.64 (s, 2H), 6.37 (s, 2H), 5.83 (s, 2H), 5.76 (s, 2H), 5.74 (s, 2H), 5.55 (s, 2H), 5.53 (s, 2H), 5.51 (s, 2H), 5.50 (s, 2H), 5.40 (s, 2H), 5.14 (s, 2H), 3.68 (s, 6H), 3.66 (s, 6H), 3.65 (s, 6H), 3.50 (s, 6H), 3.47 (s, 6H), 3.43 (s, 6H), 3.43 (s, 6H), 3.42 (s, 6H), 3.40 (s, 6H), 3.39 (s, 6H), 3.38 (s, 6H).

### Example 4

### Synthesis of Compound OP14Br

First, an orthophenylene tetradecamer represented by the following formula (7) was provided.

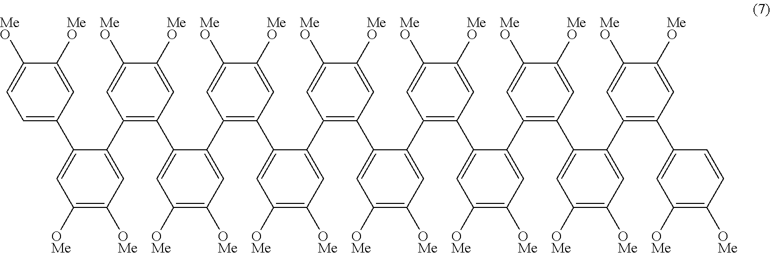 [SMILES: COc1ccc(-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2ccc(OC)c(OC)c2)cc1OC]

Next, a dimethylformamide solution (20 mL) containing N-bromosuccinimide (9.3 g, 0.53 mmol) and the above orthophenylene tetradecamer (0.59 g, 0.25 mmol) was prepared and was stirred at 0° C. for 1 hour. Furthermore, the solution was warmed to room temperature and was stirred for 4 hours. In this manner, the bromination reaction of the orthophenylene tetradecamer proceeded. Next, the reaction solution was poured into water, and extraction was performed using chloroform. The extract was washed with saturated brine and was dried with magnesium sulfate. After drying, chloroform was evaporated by vacuum distillation. The resultant crude product was purified by column chromatography to give a compound OP14Br of Example 4. The compound OP14Br is represented by the following formula (8):

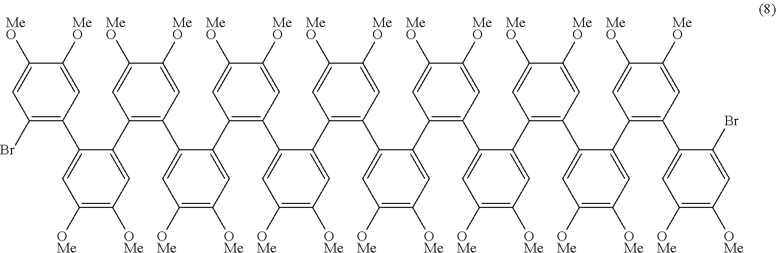 [SMILES: COc1cc(Br)c(-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2Br)cc1OC]

The compound OP14Br was identified by ¹H-NMR. FIG. 5A is a graph illustrating the ¹H-NMR spectrum of the compound OP14Br of Example 4. FIG. 5B is an enlarged view of the graph in FIG. 5A. The ¹H-NMR spectrum of the compound OP14Br was as described below. Similarly to Example 1, the ¹H-NMR spectrum indicates that the compound OP14Br has a helical structure.

¹H-NMR (600 MHz, CD₃CN): δ (ppm) 6.63 (s, 2H), 6.62 (s, 2H), 6.36 (s, 2H), 5.85 (s, 2H), 5.74 (s, 2H), 5.69 (s, 2H), 5.54 (s, 2H), 5.50 (s, 2H), 5.46 (s, 2H), 5.45 (s, 2H), 5.42 (s, 2H), 5.37 (s, 2H), 5.35 (s, 2H), 5.12 (s, 2H), 3.67 (s, 6H), 3.65 (s, 6H), 3.64 (s, 6H), 3.48 (s, 6H), 3.47 (s, 6H), 3.42 (s, 6H), 3.41 (s, 6H), 3.40 (s, 6H), 3.39 (s, 6H), 3.369 (s, 12H), 3.365 (s, 12H), 3.02 (s, 6H).

### Example 5

### Synthesis of Compound OP16Br

First, a tetrahydrofuran solution (60 mL) containing the compound OP8Br (1.0 g, 0.80 mmol) synthesized in Example 2 was prepared in an argon atmosphere. Next, 3.2 mmol of a 1.8 mol/L hexane solution of t-butyllithium was added to the solution, and the mixture was stirred at −78° C. for 10 minutes. The solution was further stirred at −40° C. for 15 minutes and was cooled again to −78° C. Next, copper cyanide powder (72 mg, 0.8 mmol) was added to the reaction solution, and the mixture was stirred at room temperature for 1.5 hours. Next, duroquinone powder (200 mg, 1.2 mmol) was added to the reaction solution, and the mixture was stirred at room temperature for 12 hours. In this manner, the coupling reaction of the compound OP8Br proceeded. Next, the reaction solution was poured into an aqueous ammonia solution, and the organic layer was extracted using ethyl acetate. The organic layer extracted was washed with a saturated aqueous ammonium chloride solution and water, and was dried with anhydrous magnesium sulfate. After drying, ethyl acetate was evaporated by vacuum distillation. The resultant crude product was purified by column chromatography to give a compound OP16Br of Example 5. The compound OP16Br is represented by the following formula (9):

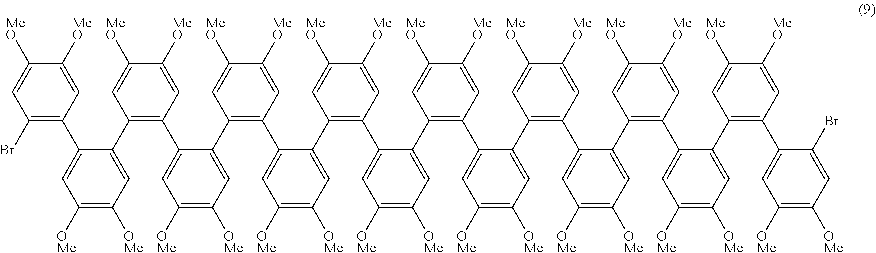 [SMILES: COc1cc(Br)c(-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2-c2cc(OC)c(OC)cc2Br)cc1OC]

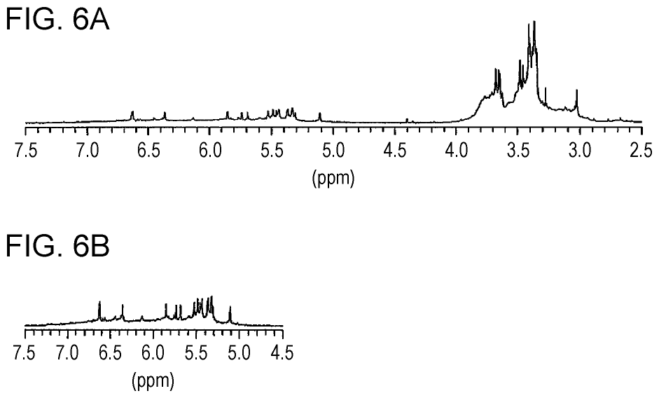

The compound OP16Br was identified by ¹H-NMR and mass spectrometry. FIG. 6A is a graph illustrating the ¹H-NMR spectrum of the compound OP16Br of Example 5. FIG. 6B is an enlarged view of the graph in FIG. 6A. The ¹H-NMR spectrum of the compound OP16Br, and the results of the mass spectrometry by electrospray ionization-time-of-flight mass spectrometry using a high-resolution mass spectrometer (HRMS) were as described below. Similarly to Example 1, the ¹H-NMR spectrum indicates that the compound OP16Br has a helical structure.

¹H-NMR (600 MHz, CD₃CN): δ (ppm) 6.624 (s, 2H), 6.616 (s, 2H), 6.36 (s, 2H), 5.84 (s, 2H), 5.73 (s, 2H), 5.68 (s, 2H), 5.52 (s, 2H), 5.48 (s, 2H), 5.45 (s, 2H), 5.43 (s, 2H), 5.37 (s, 2H), 5.36 (s, 2H), 5.33 (s, 2H), 5.32 (s, 2H), 5.30 (s, 2H), 5.10 (s, 2H), 3.67 (s, 6H), 3.64 (s, 6H), 3.63 (s, 6H), 3.47 (s, 6H), 3.45 (s, 6H), 3.401 (s, 6H), 3.398 (s, 6H), 3.39 (s, 6H), 3.37 (s, 6H), 3.36 (s, 6H), 3.354 (s, 12H), 3.349 (s, 6H), 3.341 (s, 6H), 3.337 (s, 6H), 3.02 (s, 6H). HRMS (ESI-TOF mass): calcd. for C₁₂₈H₁₂₈Br₂O₃₂[M]⁺: m/z=2334.68; found: 2335.12.

### Comparative Examples 1 and 2

A compound of Comparative Example 1, hexakis(phenylethynyl)benzene (HPEB), represented by the formula (10) below was synthesized in accordance with the methods described in K. Kondo, et al., J. Chem. Soc., Chem. Commun. 1995, 55-56, and W. Tao, et al., J. Org. Chem. 1990, 55, 63-66. A compound of Comparative Example 2, compound lf, represented by the formula (11) below was synthesized in accordance with the method disclosed in paragraph of Japanese Patent No. 5821661.

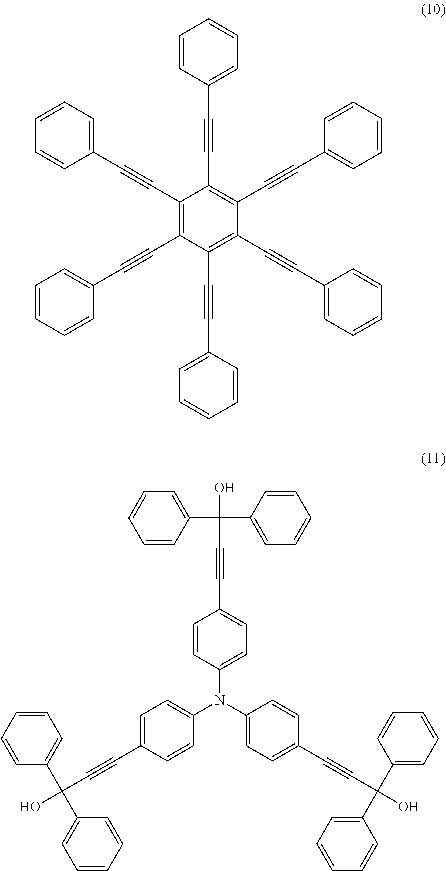

### Measurement of Two-Photon Absorption Cross-Section

The two-photon absorption cross-section of the compounds of Examples and Comparative Examples was measured with respect to light having a wavelength of 405 nm. The measurement of the two-photon absorption cross-section was performed using the z-scan technique described in J. Opt. Soc. Am. B, 2003, Vol. 20, p. 529. The light source used for the measurement of the two-photon absorption cross-section was a Ti:sapphire pulsed laser. Specifically, second harmonic waves from the Ti:sapphire pulsed laser were applied to the sample. The pulse width of the laser was 80 fs. The repetition frequency of the laser was 1 kHz. The average power of the laser was changed in the range of greater than or equal to 0.01 mW and less than or equal to 0.08 mW. The light from the laser had a wavelength of 405 nm. Specifically, the light from the laser had a central wavelength of greater than or equal to 402 nm and less than or equal to 404 nm. The full width at half maximum of the light from the laser was 4 nm.

### Measurement of Molar Absorption Coefficient

The compounds of Examples and Comparative Examples were analyzed by a method in accordance with JIS K0115: 2004 to measure the molar absorption coefficient. Specifically, first, a measurement sample was provided in which the concentration of the compound had been controlled to 500 mmol/L. An absorption spectrum of the measurement sample was measured. From the spectrum obtained, the absorbance at a wavelength of 405 nm was read. The molar absorption coefficient was calculated based on the concentration of the compound in the measurement sample and the optical path length of the cell used for the measurement.

Table 1 describes the two-photon absorption cross-section σ (GM) and the molar absorption coefficient ε (mol⁻¹·L·cm⁻¹) obtained by the above methods, and the ratio σ/ε.

TABLE 1

| | | | | Molar | |
|---|---|---|---|---|---|
| | | | Two-photon | absorption | |
| | Compound | | absorption cross- | coefficient ε | Ratio |
| | Name | Formula | section σ (GM) | (mol⁻¹ · L · cm⁻¹) | σ/ε |
| Ex. 1 | 0P4Br | (3) | 51 | 1.34 | 38 |
| Ex. 2 | 0P8Br | (4) | 73 | 1.01 | 72 |
| Ex. 3 | 0P12Br | (6) | 71 | 0.50 | 142 |
| Ex. 4 | 0P14Br | (8) | 82 | 0.49 | 167 |
| Ex. 5 | 0P16Br | (9) | 336 | 1.51 | 223 |
| Comp. | Hexakis(phenylethynyl)benzene | (10) | 23000 | 2730 | 10 |
| Ex. 1 | (HPEB) | | | | |
| Comp. | 1f | (11) | 380 | 70 | 5 |
| Ex. 2 | | | | | |

In conventional through-bond pi-conjugated compounds, the two-photon absorption cross-section σ should be large and the molar absorption coefficient ε should be low in order to increase the ratio σ/ε that reflects non-linear optical absorption characteristics. A general approach to increasing the two-photon absorption cross-section σis to extend the pi-conjugated system of the dye material. However, the extension of the chain length causes the optical absorption wavelength to shift to a longer wavelength side, and the molar absorption coefficient ε at the excitation wavelength (405 nm) is increased. That is, the enhancement in non-linear optical absorption characteristics by the above approach is limited. In the through-space pi-conjugated compound of the present disclosure, the chemical structure corresponds to the compound A represented by the formula (1). The through-space pi-conjugated compound has a helical structure twisted at a sharp angle. Thus, the compound does not increase its optical absorption wavelength even when the chain length thereof is extended, and hence the compound does not increase its molar absorption coefficient ε. That is, the extension of the chain length of the through-space pi-conjugated compound enhances the non-linear optical absorption characteristics of the through-space pi-conjugated compound.

As can be seen from Table 1, the compounds of Examples 1 to 5 that correspond to the compounds A represented by the formula (1) have a larger two-photon absorption cross-section σ with increasing chain length, but their molar absorption coefficients ε do not increase correspondingly. As a result, non-linear optical absorption characteristics σ/ε are enhanced, and two-photon absorption characteristics are improved as compared with the compounds of Comparative Examples. Thus, dye materials using the through-space conjugated system of the present disclosure can concurrently achieve a larger two-photon absorption cross-section and a lower molar absorption coefficient as the chain length is extended, and thus can attain further enhancements in non-linear optical absorption characteristics.

The two-photon absorption cross-section could not be measured by the aforementioned method for a compound OP3Br having an orthophenylene trimer structure. The compound OP3Br is represented by the formula (12) below. This result shows that n in the formula (1) needs to be an integer greater than or equal to 2. That is, the compound A needs to be an orthophenylene tetramer or higher oligomer.

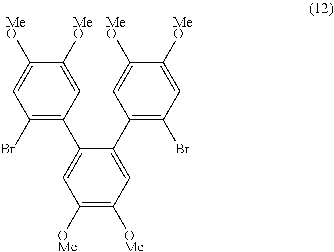 [SMILES: COc1cc(Br)c(-c2cc(OC)c(OC)cc2-c2cc(OC)c(OC)cc2Br)cc1OC]

The light absorption materials of the present disclosure may be used in such applications as recording layers in three-dimensional optical memories, and photocurable resin compositions for three-dimensional (3d) laser microfabrication. The light absorption materials of the present disclosure have highly non-linear optical absorption characteristics with respect to light having a wavelength in the short wavelength region. Thus, the light absorption materials of the present disclosure can realize very high spatial resolution in such applications as three-dimensional optical memories and modeling machines. As compared to the conventional light absorption materials, the light absorption materials of the present disclosure can preferentially exhibit two-photon absorption rather than one-photon absorption even when irradiated with a low-intensity laser beam.

What is claimed is:

1. A light absorption material comprising:
a compound represented by a formula (1) as a main component: 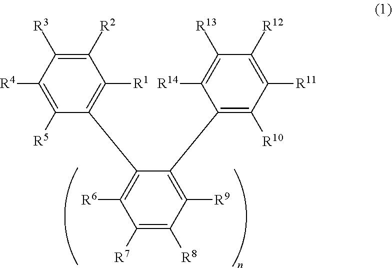
wherein R¹ to R¹⁴ each independently include at least one atom selected from the group consisting of H, C, N, O, F, P, S, Cl, I, and Br, and
n is an integer greater than or equal to 2.

2. The light absorption material according to claim 1, wherein
R¹ to R¹⁴ are each independently a hydrogen atom, a halogen atom, a saturated hydrocarbon group, a halogenated alkyl group, an unsaturated hydrocarbon group, a hydroxyl group, a carboxyl group, an alkoxycarbonyl group, an aldehyde group, an acyl group, an amide group, a nitrile group, an alkoxy group, an acyloxy group, a thiol group, an alkylthio group, a sulfonic acid group, an acylthio group, an alkylsulfonyl group, a sulfonamide group, a primary amino group, a secondary amino group, a tertiary amino group, or a nitro group.

3. The light absorption material according to claim 1, wherein
at least one selected from the group consisting of R², R³, R⁷, R⁸, R¹², and R¹³ is an electron-donating group.

4. The light absorption material according to claim 3, wherein
the electron-donating group is an alkoxy group.

5. The light absorption material according to claim 3, wherein
the electron-donating group is —OCH₃.

6. The light absorption material according to claim 1, wherein
at least one selected from the group consisting of R⁵ and R¹⁰ is an electron-withdrawing group.

7. The light absorption material according to claim 6, wherein
the electron-withdrawing group is a halogen group.

8. The light absorption material according to claim 1, wherein
the compound has a helical structure.

9. The light absorption material according to claim 1, wherein
the compound absorbs specific light.

10. The light absorption material according to claim 1, wherein
the light absorption material is used in a device utilizing light having a wavelength of greater than or equal to 390 nm and less than or equal to 420 nm.

11. A recording medium comprising:
a recording layer comprising the light absorption material according to claim 1.

12. An information recording method comprising:
providing a light source that emits light having a wavelength of greater than or equal to 390 nm and less than or equal to 420 nm; and
focusing the light from the light source and applying the light to the recording layer in the recording medium according to claim 11.

13. An information reading method for reading information recorded by the information recording method according to claim 12, the information reading method comprising:
applying light to the recording layer to measure an optical characteristic of the recording layer; and
reading the information from the recording layer.

14. The information reading method according to claim 13, wherein
the optical characteristic is intensity of light reflected at the recording layer.
